(19) United States
(12) Patent Application Publication
(10) Pub. No.: US 2020/0119434 A1
(43) Pub. Date: Apr. 16, 2020

(54) CONTROL METHOD, UNMANNED AERIAL VEHICLE, AND COMPUTER READABLE STORAGE MEDIUM

(71) Applicant: SZ DJI TECHNOLOGY CO., LTD., Shenzhen (CN)

(72) Inventor: Dong LI, Shenzhen (CN)

(21) Appl. No.: 16/713,514

(22) Filed: Dec. 13, 2019

Related U.S. Application Data
(63) Continuation of application No. PCT/CN2017/090932, filed on Jun. 29, 2017.

(51) Int. Cl. H01Q 1/28; H01Q 3/08; G05D 1/10; G05D 1/00

(52) U.S. Cl. CPC H01Q 1/28; G05D 1/0094; G05D 1/101; H01Q 3/08

(57) ABSTRACT

A radiation direction control method includes obtaining a relative position of an unmanned aerial vehicle (UAV) relative to a control terminal communicating with the UAV, and driving an antenna of the UAV to move based on the relative position to cause a maximum-radiation direction of the antenna to face toward the control terminal.

### CROSS-REFERENCE TO RELATED APPLICATION

This application is a continuation of International Application No. PCT/CN2017/090932, filed on Jun. 29, 2017, the entire content of which is incorporated herein by reference.

### TECHNICAL FIELD

The present disclosure relates to the field of wireless communication and, more particularly, to a method for controlling radiation direction of an antenna of an unmanned aerial vehicle (UAV), a UAV, and a computer-readable storage medium.

### BACKGROUND

An antenna mounted at a UAV is often a directional antenna. When the UAV changes its position, a radiation pattern of the antenna does not adjust correspondingly with the change of the UAV attitude, resulting in a maximum-radiation direction of the radiation pattern of the antenna mounted at the flying UAV unable to face toward a ground control terminal. Thus, an image transmission quality is degraded and a control distance of the UAV is shortened.

### SUMMARY

In accordance with the disclosure, there is provided a radiation direction control method including obtaining a relative position of an unmanned aerial vehicle (UAV) relative to a control terminal communicating with the UAV, and driving an antenna of the UAV to move based on the relative position to cause a maximum-radiation direction of the antenna to face toward the control terminal.

Also in accordance with the disclosure, there is provided an unmanned aerial vehicle (UAV) including an antenna, a processor configured to obtain a relative position of the UAV relative to a control terminal communicating with the UAV, and an actuator configured to drive the antenna to move based on the relative position to cause a maximum-radiation direction of the antenna to face toward the control terminal.

Also in accordance with the disclosure, there is provided a computer-readable storage medium storing a computer program that, when executed by a processor, causes the processor to obtain a relative position of an unmanned aerial vehicle (UAV) relative to a control terminal communicating with the UAV, and drive an antenna of the UAV to move based on the relative position to cause a maximum-radiation direction of the antenna to face toward the control terminal.

### BRIEF DESCRIPTION OF THE DRAWINGS

The above described and/or additional aspects and advantages of the present disclosure become more apparent and readily understood with reference to the accompanying drawings.

FIG. 1 is a flowchart of a control method according to an example embodiment of the present disclosure.

FIG. 2 is a schematic view showing an operation state of a UAV according to an example embodiment of the present disclosure.

FIG. 3 is a block diagram of a UAV according to an example embodiment of the present disclosure.

FIG. 4 is a schematic view of a radiation direction of an antenna according to an example embodiment of the present disclosure.

FIG. 5 is a structural view of a UAV according to an example embodiment of the present disclosure.

FIG. 6 is a flowchart of a control method according to another example embodiment of the present disclosure.

FIG. 7 is a block diagram of a UAV according to another example embodiment of the present disclosure.

FIG. 8 is a flowchart of a control method according to another example embodiment of the present disclosure.

FIG. 9 is a schematic view showing an operation state of a UAV according to another example embodiment of the present disclosure.

FIG. 10 is a schematic view showing the operation state of the UAV according to another example embodiment of the present disclosure.

FIG. 11 is a schematic view showing the operation state of the UAV according to another example embodiment of the present disclosure.

FIG. 12 is a schematic view showing the operation state of the UAV according to another example embodiment of the present disclosure.

FIG. 13 is a schematic view showing the operation state of the UAV according to another example embodiment of the present disclosure.

FIG. 14 is a schematic view showing the operation state of the UAV according to another example embodiment of the present disclosure.

FIG. 15 is a flowchart of a control method according to another example embodiment of the present disclosure.

FIG. 16 is a flowchart of a control method according to another example embodiment of the present disclosure.

FIG. 17 is a schematic diagram of connection between a UAV and a computer-readable storage medium according to an example embodiment of the present disclosure.

The numerals and labels in the drawings are summarized below.
10 UAV
11 Antenna assembly
112 Antenna
1121 Radiation surface
114 Movable member
12 Processor
13 Actuator
14 Vehicle body
15 Arm
16 Stand
162 Pivot
17 Gimbal
18 Barometer
19 Global positioning system (GPS)
20 Photographing device
30 Control terminal
40 Computer-readable storage medium

### DETAILED DESCRIPTION OF THE EMBODIMENTS

The embodiments of the present disclosure are described in detail below. Examples of the embodiments are illustrated in the accompanying drawings, where the same or similar reference numerals indicate the same or similar elements or elements having the same or similar functions. The embodiments of the present disclosure described below with reference to the accompanying drawings are intended to be illustrative and should not be construed as limiting.

In the description of the embodiments of the present disclosure, it should be understood that terms such as “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, etc. are referring to attitude or position relationship based on the attitude or position relationship shown in the accompanying drawings for convenience of illustrating and simplifying the embodiments of the present disclosure, and do not indicate or imply that the described devices or elements have to be at the particular attitude, have to have the particularly oriented structures, or have to operate in the particular attitude. Thus, they should not be construed as limiting. In addition, terms such as “first” and “second” are used for descriptive purposes only and are not to be construed as indicating or implying a relative importance or implicitly indicating a quantity of described technical features. As such, the feature preceded by “first” or “second” may include one or more features explicitly or implicitly. In the description of the embodiments of the present disclosure, the phrase “a plurality of” refers to two or more unless specifically defined otherwise.

In the description of the embodiments of the present disclosure, terms such as “install”, “couple”, and “connect” should be interpreted broadly unless specifically defined and limited otherwise. For example, the term “connect” may refer to fixedly connect, detachably connect, integrally connect, mechanically connect, electrically connect, communicatively connect, directly connect, indirectly connect through an intermediate medium, internally connect two elements, or interact with each other between two elements. For those skilled in the art, the specific meaning of the above terms should be understood on a case-by-case basis in the context of the embodiments of the present disclosure.

In the embodiments of the present disclosure, unless specifically defined or limited otherwise, a first feature being “above” or “below” a second feature may include a direct contact between the first feature and the second feature or an indirect contact between the first feature and the second feature through an intermediate feature. Moreover, the first feature being “over”, “above”, or “on” the second feature may include the first feature being directly over the second feature, the first feature being obliquely above the second feature, or the first feature being higher than the second feature. Similarly, the first feature being “under”, “below”, or “lower than” the second feature may include the first feature being directly under the second feature, the first feature being obliquely below the second feature, or the first feature being lower than the second feature.

The following description provides various examples for implementing different structures of the embodiments of the present disclosure. For simplifying the description of embodiments of the present disclosure, components and arrangements in specific examples are described below. They are merely examples and are not intended to limit the disclosure. In addition, reference numerals and/or reference labels may be repeated in different examples. Such repetitions are intended for simplification and clarity, and do not indicate by themselves the relationships between various embodiments and/or arrangements discussed. In addition, the embodiments of the present disclosure provide examples of various specific processes and materials. However, one of ordinary skill in the art will recognize the use of other processes and/or materials.

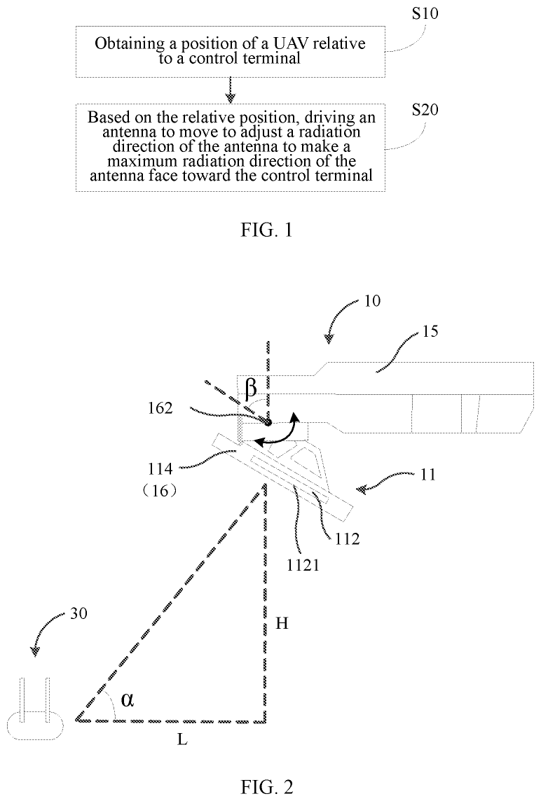

In some embodiments, referring to FIG. 1 and FIG. 2, the method is applied to control a radiation direction of an antenna 112 of an unmanned aerial vehicle (UAV) 10. The UAV 10 communicates with a control terminal 30. The UAV 10 includes an antenna assembly 11. The antenna assembly 11 includes the antenna 112.

As shown in FIG. 1, at S10, a position of the UAV 10 relative to the control terminal 30 is obtained. At S20, based on the relative position, the antenna 112 is driven to move to adjust the radiation direction of the antenna 112 to cause a maximum-radiation direction of the antenna 112 to face toward the control terminal 30. The maximum-radiation direction of the antenna 112 refers to a radiation direction having the highest intensity among all radiation directions of the antenna 112.

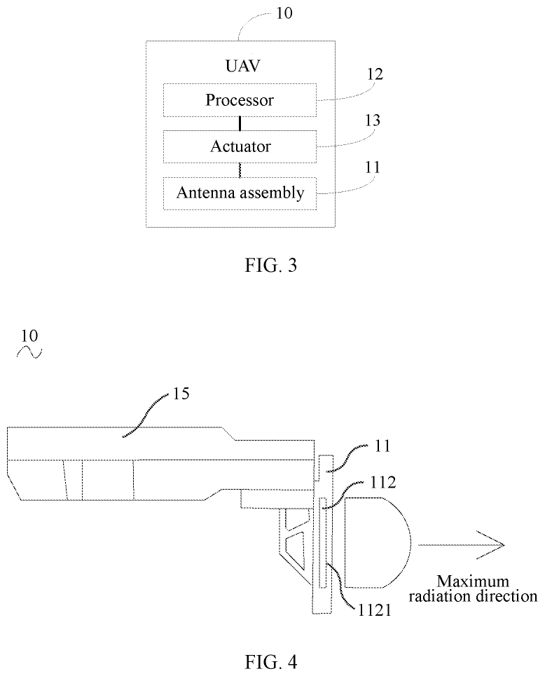

As described above, the UAV 10 communicates with the control terminal 30. The UAV 10 includes the antenna assembly 11, and the antenna assembly 11 includes the antenna 112. In some embodiments, as shown in FIG. 3, the UAV also includes a processor 12 and an actuator 13. The control method consistent with the disclosure can be implemented by the UAV 10. For example, the processor 12 is configured to execute S10 of the control method and the actuator 13 is configured to execute S20 of the control method.

In other words, the processor 12 is configured to obtain the position of the UAV 10 relative to the control terminal 30. The actuator 13 is configured to drive the antenna 112 to move based on the relative position to adjust the radiation direction of the antenna 112 to cause the maximum-radiation direction of the antenna 112 to face toward the control terminal 30.

In the control method and the UAV 10 consistent with embodiments of the disclosure, the antenna 112 is driven to move based on the position of the UAV 10 relative to the control terminal 30, such that the maximum-radiation direction of the antenna 112 always faces toward the control terminal 30. Thus, the image transmission quality of the UAV 10 is improved and the control distance of the UAV 10 is increased.

In some embodiments, referring to FIG. 4, the antenna 112 may include a directional antenna. The maximum-radiation direction of the antenna 112 is perpendicular to a radiating surface 1121 and faces toward the control terminal 30. In this case, the directional antenna has the maximum strength of transmitting and receiving electromagnetic waves in one or more specific directions, and has zero or very low strength of transmitting and receiving the electromagnetic waves in other directions. The use of the directional antenna increases effective utilization of radiation power and hence increases signal strength of communication between the UAV 10 and the control terminal 30.

In some embodiments, the actuator 13 is connected to the antenna assembly 11. Based on the position of the UAV 10 relative to the control terminal 30, the actuator 13 drives the antenna 112 to move to adjust the radiation direction of the antenna 112, such that the maximum-radiation direction of the antenna 112 faces toward the control terminal 30. The movement of the antenna 112 driven by the actuator 13 may be movement of the antenna 112 directly driven by the actuator 13 or may be the movement of the antenna 112 driven by other component of the antenna assembly 11, which in turn is driven by the actuator 13.

In some embodiments, referring again to FIG. 2, the antenna assembly 11 also includes a movable member 114. The antenna 112 is disposed at the movable member 114. S20 of the control method may be implemented by driving the movable member 114 to move the antenna 112.

In other words, the actuator 13 moves the antenna 112 by driving the movable member 114 to move to adjust the radiation direction of the antenna 112, such that the maximum-radiation direction of the antenna 112 faces toward the control terminal 30.

In some embodiments, mounting the antenna 112 on the movable member 114 includes mounting the antenna 112 inside the movable member 114 or mounting the antenna 112 outside the movable member 114. In some other embodiments, the antenna 112 can include a hole or a groove drilled on the movable member 114. When the antenna 112 is mounted inside or outside the movable member 114, a position of the antenna 112 relative to the movable member 114 is fixed. The antenna 112 may be fixed to the movable member 114 by snapping, threaded connection, or a combination of snapping and threaded connection. When the antenna 112 is mounted outside the movable member 114, the antenna 112 may be mounted at the surface of the movable member 114, or may be mounted to the movable member 114 with a gap in between, or may be mounted at the movable member 114 with an angle in between. In some embodiments, the antenna 112 is mounted inside the movable member 114 and the movable member 114 can protect the antenna 112. The actuator 13 moves the antenna 112 by driving the movable member 114 to move, such that the maximum-radiation direction of the antenna 112 faces toward the control terminal 30.

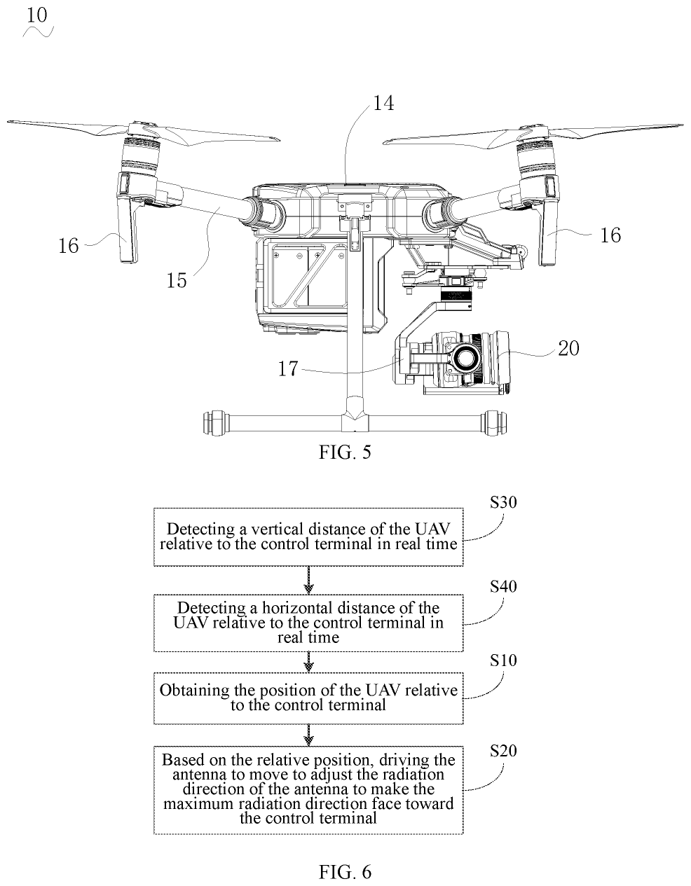

In some embodiments, referring to FIG. 5, the UAV 10 includes a vehicle body 14 and one or more arms 15 extending from the vehicle body 14. The movable member 114 also includes one or more stands 16 disposed at the vehicle body 14 or the one or more arms 15.

In other words, the movable member 114 may be the one or more stands 16. The one or more stands 16 are disposed at the vehicle body 14 or the one or more arms 15. On one hand, the one or more stands 16 provide support for the UAV 10 during landing and take-off. On the other hand, the one or more stands 16 may serve as the movable member 114. The actuator 13 moves the antenna 112 by driving the one or more stands 16 to move, thereby saving cost for additionally making the movable member 114. When the movable member 114 serves as the one or more stands 16, the movement of the one or more stands 16 driven by the actuator 13 does not affect normal operation of the UAV 10.

In some embodiments, the movable member 114 may also include the one or more arms 15, a gimbal 17, or a photographing device 20 (e.g., camera) mounted at the gimbal 17.

In some embodiments, the UAV 10 includes the gimbal 17. The movable member 114 is disposed at the gimbal 17.

The gimbal 17 is a support mechanism for mounting and fixing the photographing device 20. When adjusting the radiation direction of the antenna 112, the actuator 13 moves the antenna 112 by driving the movable member 114 disposed at the gimbal 17 to move.

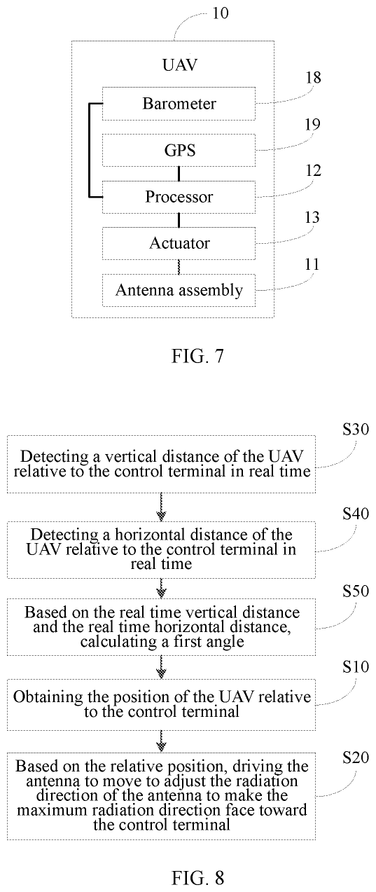

In some embodiments, referring to FIG. 6 and FIG. 7, the control method also includes detecting in real time a vertical distance between the UAV 10 and the control terminal 30 (S30) and detecting in real time a horizontal distance between the UAV 10 and the control terminal 30 (S40).

In some embodiments, the UAV 10 also includes a barometer 18 and a global positioning system (GPS) 19. The barometer 18 is configured to execute S30 of the control method. The GPS 19 is configured to execute S40 of the control method.

In other words, the barometer 18 is configured to detect the vertical distance between the UAV 10 and the control terminal 30 in real time. The GPS 19 is configured to detect the horizontal distance between the UAV 10 and the control terminal 30 in real time.

In some embodiments, the barometer 18 detects a height of the UAV 10 relative to the ground based on a difference in atmospheric pressures at different altitudes. Assuming that the control terminal 30 is located at the ground, the vertical distance of the UAV 10 relative to the control terminal 30 is obtained in real time. The GPS 19 is configured to detect coordinates of horizontal positions of the UAV 10 and the control terminal 30, and to obtain the horizontal distance of the UAV 10 relative to the control terminal 30 in real time. The processor 12 obtains the real time vertical distance and the real time horizontal distance of the UAV 10 relative to the control terminal 30 from the barometer 18 and the GPS 19 respectively, thereby obtaining the position of the UAV 10 relative to the control terminal 30.

The GPS 19 may also be configured to detect height information of the UAV 10 and the control terminal 30. However, a low cost GPS 19 refreshes positioning data infrequently. When the UAV 10 flies at a high speed, such positioning data may be out-of-date. In some embodiments, the real time vertical distance of the UAV 10 relative to the control terminal 30 may be independently detected by the barometer 18 and the GPS 19. The independently detected data may be processed and fused to obtain a final real time vertical distance, thereby improving detection accuracy.

In some embodiments, referring to FIG. 2 and FIG. 8, the control method also includes the following.

At S50, based on the real time vertical distance and the real time horizontal distance, a first angle is calculated. The first angle satisfies the equation below:

α=arctan(H/L),

where α is the first angle, H is the real time vertical distance, and L is the real time horizontal distance.

Based on the relative position, the antenna 112 is driven to move to adjust the radiation direction of the antenna 112, such that the maximum-radiation direction of the antenna 112 faces toward the control terminal 30. At S20, the antenna 112 is rotated, such that a second angle formed between the radiation surface 1121 of the antenna 112 and a plumb line is equal to the first angle.

In some embodiments, the processor 12 is configured to execute S50 of the control method.

In other words, the processor is further configured to calculate the first angle based on the real time vertical distance and the real time horizontal distance. The first angle satisfies the equation α=arctan(H/L), where a is the first angle, H is the real time vertical distance, and L is the real time horizontal distance. The actuator 13 drives the antenna 112 to rotate, such that the second angle formed between the radiation surface 1121 of the antenna 112 and the plumb line is equal to the first angle. Thus, the radiation direction of the antenna 112 is adjusted to cause the maximum-radiation direction of the antenna 112 to face toward the control terminal 30.

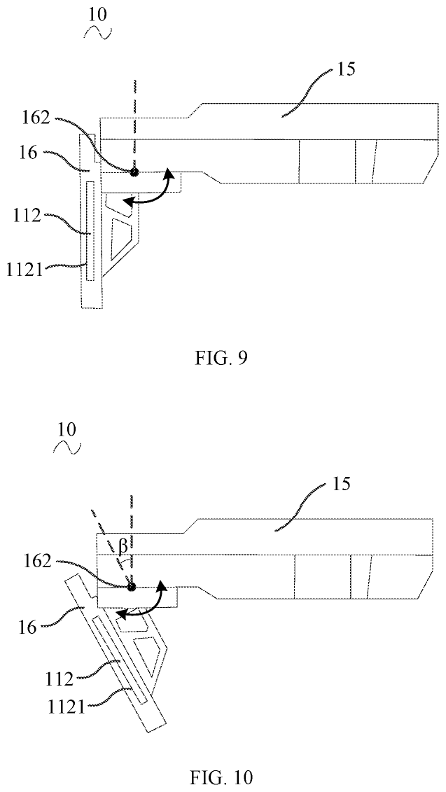

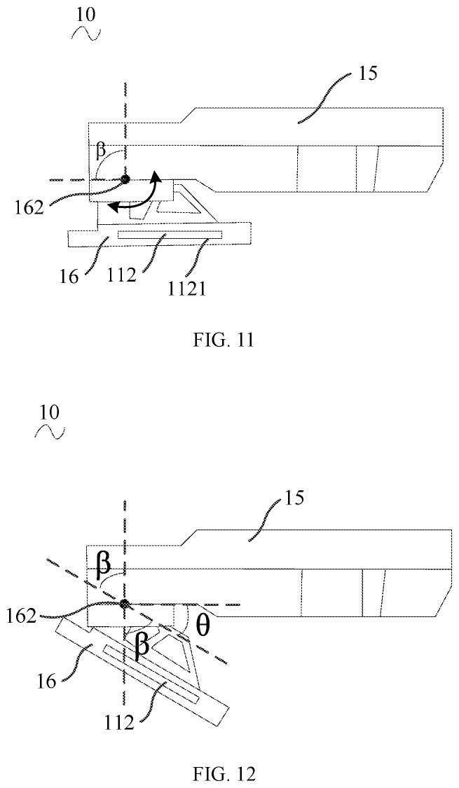

In some embodiments, referring to FIGS. 9-11 and FIG. 2, the antenna 112 is disposed inside the one or more stands 16. The one or more stands 16 are mounted at the one or more arms 15 and rotate around the one or more arms 15, respectively. For example, the one or more stands 16 are connected to the one or more arms 15 through one or more pivots 162, respectively. The one or more stands 16 rotate around the one or more pivots 162 respectively within a range approximately between 0 and 90 degrees. The first angle α is formed between a connection line connecting the UAV 10 and the control terminal 30 and the horizontal line. The second angle β is formed between the radiation surface 1121 of the antenna 112 and the plumb line. As shown in FIG. 9, FIG. 10, FIG. 2, and FIG. 11, the second angle β is 0°, 30°, 60°, and 90°, respectively. The second angle β is an acute angle or a right angle formed between the radiation surface 1121 of the antenna 112 and the plumb line. The actuator 13 drives the antenna 112 to rotate around the pivot 162, such that the second angle β is equal to the first angle α, thereby causing the maximum-radiation direction of the antenna 112 to face toward the control terminal 30.

In some embodiments, a plurality of first angles α, such as α1, α2, α3, α4, . . . , may be calculated consecutively by repetitively applying the equation α=arctan(H/L). If differences among α1, α2, and α3 are relatively small, e.g., both α2-α1 and α3-α1 are smaller than an angle threshold (e.g., 1°), then the actuator 13 will not drive the antenna 112 to rotate around the pivot 162 and the antenna 112 maintains the previous radiation direction, that is, 0=α1, to save energy. When α4-α1 exceeds the angle threshold, the actuator 13 drives the antenna 112 to rotate around the pivot 162 to adjust the radiation direction of the antenna 112, such that the maximum-radiation direction of the antenna 112 faces toward the control terminal 30, that is, β=α4.

In some embodiments, the UAV 10 also includes a memory. The memory stores a truth table including mapping relationships between the second angle β and combinations of the real time vertical distances and the real time horizontal distances. The actuator 13 may directly retrieve the second angle β from the truth table based on the real time vertical distance and the real time horizontal distance and controls the antenna 112 to rotate by the second angle correspondingly.

In some embodiments, the UAV 10 sends the real time vertical distance and the real time horizontal distance to the control terminal 30 (e.g., the horizontal distance calculated in real time based on the GPS coordinate of the UAV 10 and the GPS coordinate of the control terminal 30). Based on the real time vertical distance and the real time horizontal distance, the control terminal 30 calculates the first angle α and then sends the first angle α back to the UAV 10. Based on the first angle α, the UAV 10 adjusts the radiation direction of the antenna 112 to cause the maximum-radiation direction of the antenna to face toward the control terminal 30.

In some embodiments, the UAV 10 sends the real time vertical distance and the GPS coordinate of the UAV 10 to the control terminal 30. Based on the GPS coordinate of the UAV 10 and the GPS coordinate of the control terminal 30, the control terminal 30 calculates the real time horizontal distance between the UAV 10 and the control terminal 30. Based on the real time vertical distance and the real time horizontal distance, the control terminal 30 calculates the first angle α and then sends the first angle α back to the UAV 10. Based on the first angle α, the UAV 10 adjusts the radiation direction of the antenna 112 to cause the maximum-radiation direction of the antenna to face toward the control terminal 30.

In some embodiments, the actuator 13 may be an electric motor. The electric motor is configured to measure an angle β of the stand 16 relative to the arm 15 of the UAV 10.

Referring to FIG. 12, when the arm 15 of the UAV 10 is horizontal, β+θ=90°, the actuator 13 drives the antenna 112 to rotate around the pivot 162, such that θ=90°−β=90°−α. In other words, after the antenna 112 rotates around the pivot 162 to 90°−α, the maximum-radiation direction of the antenna 112 faces toward the control terminal 30.

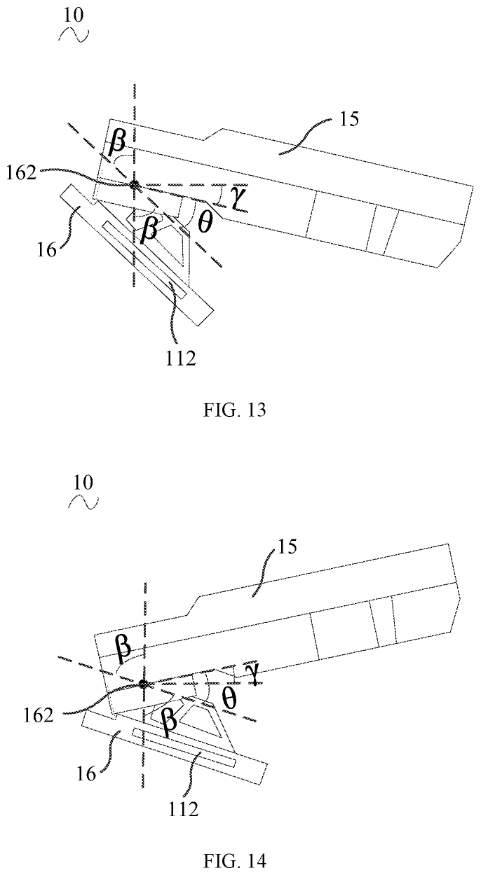

When the arm 15 of the UAV 10 is tilted (e.g., the tilted angle is greater than 10°), the attitude of the UAV 10 itself needs to be included in the calculation. Referring to FIG. 13, when the arm 15 of the UAV 10 is tilted clockwise, and assuming an angle between the arm 15 of the UAV 10 and the horizontal line is γ, β+θ+γ=90°. The actuator 13 drives the antenna 112 to rotate around the pivot 162, such that θ=90°+−β−γ=90°−α−γ. In other words, after the antenna 112 rotates around the pivot 162 by 90°−α−γ, the maximum-radiation direction of the antenna 112 faces toward the control terminal 30. Referring to FIG. 14, when the arm 15 of the UAV 10 is tilted counterclockwise, and assuming the angle between the arm 15 of the UAV 10 and the horizontal line is γ, β+θ−γ=90°. The actuator 13 drives the antenna 112 to rotate around the pivot 162, such that θ=90°−β+γ=90°−α+γ. In other words, after the antenna 112 rotates around the pivot 162 by 90°−α+γ, the maximum-radiation direction of the antenna 112 faces toward the control terminal 30.

In some embodiments, the angle γ between the arm 15 of the UAV 10 and the horizontal line may be a pitch angle of the UAV 10. The UAV 10 may calculate the pitch angle through the on-board IMU. The pitch angle is the angle γ.

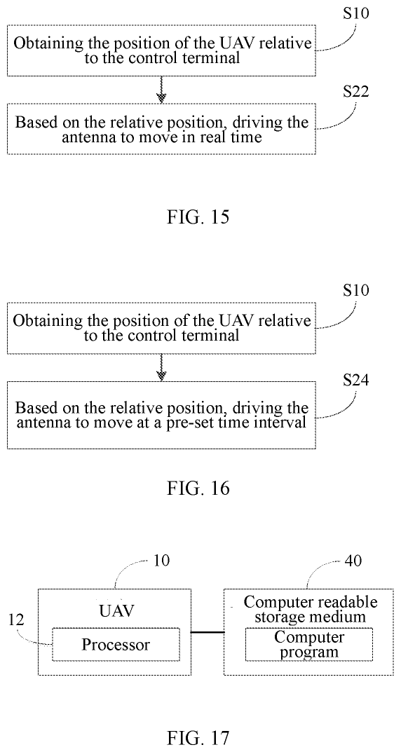

In some embodiments, referring to FIG. 15 and FIG. 16, S20 may include driving the antenna 112 to move in real time based on the relative position (S22 in FIG. 15), or driving the antenna 112 to move at a pre-set time interval based on the relative position (S24 in FIG. 16).

In some embodiments, the actuator 13 is configured to execute S22 or S24 of the control method.

In other words, the actuator 13 may drive the antenna 112 to move in real time based on the relative position, or may drive the antenna 112 to move at the pre-set time interval based on the relative position.

The actuator 13 drives the antenna 112 to move in real time based on the position of the UAV 10 relative to the control terminal 30, such that the maximum-radiation direction of the antenna 112 consistently faces toward the control terminal 30.

In a short period of time, the position of the UAV 10 relative to the control terminal 30 usually does not change substantially. As such, the antenna 112 may temporarily maintain the previous radiation direction to reduce unnecessary movement of the antenna assembly 11 to save energy. After the pre-set time interval (e.g., 2 s, 3 s, or 5 s, etc.), the processor obtains the position of the UAV 10 relative to the control terminal 30 again. The actuator 13 drives the antenna 112 to move again based on the updated relative position to adjust the radiation direction of the antenna 112, such that the maximum-radiation direction of the antenna 112 faces toward the control terminal 30.

In some embodiments, the antenna 112 may include a dipole antenna, a monopole antenna, an inverted-F antenna (IFA), or a loop antenna.

In some embodiments, the antenna 112 is the dipole antenna. The dipole antenna has the advantages of simple structure and easy power supply. The dipole antenna may be driven to move by the actuator 13 or may be disposed at the movable member 114 and driven to move by the movable member 114.

The present disclosure also provides a computer-readable storage medium. Referring to FIG. 17, the computer storage medium 40 includes a computer program applied to the UAV 10. The UAV 10 communicates with the control terminal 30. The UAV 10 includes the antenna assembly 11. The antenna assembly 11 includes the antenna 112. The computer program may be executed by the processor 12 to implement a control method consistent with the disclosure, such as one of the example methods described above.

For example, the computer program may be executed by the processor to implement the control method below.

At S10, a position of the UAV 10 relative to the control terminal 30 is obtained.

At S20, based on the relative position, the antenna 112 is driven to move to adjust the radiation direction of the antenna 112 to cause the maximum-radiation direction of the antenna 112 to face toward the control terminal 30.

In the description of the specification, phrases such as “one embodiment,” “some embodiments,” “illustrative embodiments,” “example,” “specific example,” or “some examples” refer to that specific feature, structure, material, or characteristic described in the embodiments or examples are included in at least one of the embodiments or examples of the present disclosure. In the specification, the above phrases are for illustrative purposes and do not necessarily mean the same embodiment or example. Moreover, the described specific feature, structure, material, or characteristic may be combined in any suitable manner in one or more embodiments or examples.

Any process or method described in the flowcharts or in other manners may be construed as one or more modules, fragments, or portions of executable instruction code for implementing certain logical functions or steps of the process. The scope of the embodiments of the present disclosure can include additional implementations, in which the functions may be performed in a different order shown or discussed, including a substantially simultaneous manner or an opposite order depending on the functions involved. It should be understood by those skilled in the art to which the embodiments of the present disclosure pertain.

The logic and/or step described in the flowcharts or in other manners may be construed as an ordered list of executable instructions for implementing logical functions, and may be embodied in any computer-readable storage medium for execution by an instruction execution system, apparatus, or device (e.g., a computer-based system, a system including a processing module, or other system capable of retrieving instructions and executing instructions from an instruction execution system, apparatus, or device) or a combination of the instruction execution system, apparatus, or device. In the context of the specification, “computer-readable storage medium” may be any apparatus that can contain, store, communicate, propagate, or transport a program for use in an instruction execution system, apparatus, or device, or in a combination of the instruction execution system, apparatus, or device. More examples (non-exhaustive list) of the computer-readable storage medium include: electrical connections (control method) having one or more wires, a portable computer disk cartridge (magnetic apparatus), a random-access memory (RAM), a read-only memory (ROM), an erasable programmable read-only memory (EPROM or flash memory), an optical fiber apparatus, and a portable compact disk read-only memory (CD-ROM). In addition, the computer-readable storage medium may even be papers or other suitable medium on which the program can be printed. The papers or other suitable medium may be optically scanned, edited, interpreted, or processed in other suitable manner to electronically obtain the program and later to store the program in a computer memory.

It should be understood that the portions of the embodiments of the present disclosure may be implemented in hardware, software, firmware, or a combination thereof. In the above-described embodiments, multiple steps or methods may be stored in the memory and may be implemented by having the suitable instruction execution system execute the software or the firmware. For example, if implemented in hardware, as in another embodiment, any one or any combination of the following techniques well known in the art may be utilized: a discrete logic circuit including logic gates for performing logical functions on data signals, an application specific integrated circuit having suitable combinational logic gates, a programmable gate array (PGA), and a field programmable gate array (FPGA), etc.

One of ordinary skill in the art may understand that all or some steps of the disclosed methods may be implemented by the program instructing related hardware. The program may be stored in the computer-readable storage medium. When being executed, the program implements one or more steps of the disclosed methods.

In addition, various functional blocks of the embodiments of the present disclosure may be integrated into one processing module or circuit, or may be physically separate modules or circuits, or may have two or more functional blocks integrated into one module or circuit. The integrated module or circuit may be implemented in hardware or may be implemented in software functional modules. When implemented in software functional modules and sold or used as an independent product, the integrated module may be stored in the computer-readable storage medium.

The above-described storage medium may be a read-only memory, a magnetic disk, or an optical disk.

The foregoing descriptions are merely some implementation manners of the present disclosure, but the scope of the present disclosure is not limited thereto. Without departing from the spirit and principles of the present disclosure, any modifications, equivalent substitutions, and improvements, etc., shall fall within the scope of the present disclosure.

What is claimed is:

1. A radiation direction control method comprising:
obtaining a relative position of an unmanned aerial vehicle (UAV) relative to a control terminal communicating with the UAV; and
driving, based on the relative position, an antenna of the UAV to move to cause a maximum-radiation direction of the antenna to face toward the control terminal.

2. The control method of claim 1, wherein driving the antenna includes driving a movable member connected to the antenna to move the antenna.

3. The control method of claim 2, wherein:
the UAV further includes a vehicle body and an arm extending from the vehicle body; and
the movable member includes a stand disposed at the vehicle body or at the arm.

4. The control method of claim 2, wherein:
the UAV further includes a gimbal; and
the movable member is disposed at the gimbal.

5. The control method of claim 1, further comprising:
detecting a vertical distance of the UAV relative to the control terminal in real time; and
detecting a horizontal distance of the UAV relative to the control terminal in real time.

6. The control method of claim 5, further comprising:
calculating a first angle as an arc tangent of a ratio of the vertical distance to the horizontal distance;
wherein driving the antenna includes driving the antenna to rotate to cause a second angle equal to the first angle, the second angle being between a radiation surface of the antenna and a plumb line.

7. The control method of claim 1, wherein driving the antenna includes:
driving, in real time, the antenna to move based on the relative position; or
driving, at a pre-set time interval, the antenna to move based on the relative position.

8. The control method of claim 1, wherein the antenna includes a dipole antenna, a monopole antenna, an inverted-F antenna (IFA), or a loop antenna.

9. An unmanned aerial vehicle (UAV) comprising:
an antenna;
a processor configured to obtain a relative position of the UAV relative to a control terminal communicating with the UAV; and
an actuator configured to, based on the relative position, drive the antenna to move to cause a maximum-radiation direction of the antenna to face toward the control terminal.

10. The UAV of claim 9, further comprising:
a movable member;
wherein:
the antenna is disposed at the movable member; and
the actuator is configured to, based on the relative position, drive the movable member to move the antenna.

11. The UAV of claim 10, further comprising:
a vehicle body; and
an arm extending from the vehicle body;
wherein the movable member includes a stand disposed at the vehicle body or at the arm.

12. The UAV of claim 10, further comprising:
a gimbal;
wherein the movable member is disposed at the gimbal.

13. The UAV of claim 9, further including:
a barometer configured to detect a vertical distance of the UAV relative to the control terminal in real time; and
a global positioning system (GPS) configured to detect a horizontal distance of the UAV relative to the control terminal in real time.

14. The UAV of claim 13, wherein:
the processor is further configured to calculate a first angle as an arc tangent of a ratio of the vertical distance to the horizontal distance; and
the actuator is configured to drive the antenna to rotate to cause a second angle equal to the first angle, the second angle being between a radiation surface of the antenna and a plumb line.

15. The UAV of claim 9, wherein the actuator is configured to:
drive, in real time, the antenna to move based on the relative position; or
drive, at a pre-set time interval, the antenna to move based on the relative position.

16. The UAV of claim 9, wherein the antenna includes a dipole antenna, a monopole antenna, an inverted-F antenna (IFA), or a loop antenna.

17. A computer-readable storage medium storing a computer program that, when executed by a processor, causes the processor to:
obtain a relative position of an unmanned aerial vehicle (UAV) relative to a control terminal communicating with the UAV; and
drive, based on the relative position, an antenna of the UAV to move to cause a maximum-radiation direction of the antenna to face toward the control terminal.

18. The computer-readable storage medium of claim 17, wherein the computer program further causes the processor to drive a movable member connected to the antenna to move the antenna.

19. The computer-readable storage medium of claim 17, wherein the computer program further causes the processor to:
detect a vertical distance of the UAV relative to the control terminal in real time; and
detect a horizontal distance of the UAV relative to the control terminal in real time.

20. The computer-readable storage medium of claim 19, wherein the computer program further causes the processor to:
calculate a first angle as an arc tangent of a ratio of the vertical distance over the horizontal distance; and
drive the antenna to rotate to cause a second angle equal to the first angle, the second angle being between a radiation surface of the antenna and a plumb line.
